(19) United States
(12) Patent Application Publication
(10) Pub. No.: US 2018/0188570 A1
(43) Pub. Date: Jul. 5, 2018

(54) DISPLAY PANEL AND DISPLAY DEVICE

(71) Applicants: HKC Corporation Limited, Shenzhen City (CN); Chongqing HKC Optoelectronics Technology Co., ltd., Chongqing (CN)

(72) Inventor: YU-JEN CHEN, Chongqing (CN)

(21) Appl. No.: 15/856,580

(22) Filed: Dec. 28, 2017

Related U.S. Application Data
(63) Continuation of application No. PCT/CN2017/106318, filed on Oct. 16, 2017.

(30) Foreign Application Priority Data
Dec. 30, 2016 (CN) 201611271036.9

(51) Int. Cl. G02F 1/1343; G02F 1/1362

(52) U.S. Cl. CPC G02F 1/1343; G09G 2300/0439; G02F 1/136213; G02F 1/136286

(57) ABSTRACT

The present invention discloses a pixel structure, and it includes: a pixel electrode; an active switch coupled to the pixel electrode; a common line and a first storage capacitor formed between the pixel electrode and the common line; and a cross conductive line and a second storage capacitor is formed between the pixel electrode and the cross conductive line.

### FIELD OF THE DISCLOSURE

The present application relates to a pixel structure, and more particularly to a method of manufacturing a pixel structure which can improve the coupling effect.

### BACKGROUND

In recent years, with advances in technology, a number of different display devices such as liquid crystal display (Liquid Crystal Display, LCD) or electroluminescent (Electro Luminescence, EL) display devices have been widely used in flat panel displays. Take liquid crystal display as an example, most of the liquid crystal display is used for the backlit LCD display, which is constituted by a liquid crystal display panel and backlight module. The liquid crystal display panel is composed of two transparent substrates and the liquid crystal enclosed between the substrates.

Conventional liquid crystal displays provide the data signal by the plurality of pixels in accordance with image electrodes, and controls the light transmittance of the plurality of pixel units to display a desired image. Specifically, each pixel electrode is respectively coupled to the data lines and scan lines. The scan lines are coupled to a TFT and a pixel electrode. By turned on the scan line to control the TFT, the data line charges for the pixel electrode. However, the data line produces multiple parasitic capacitance in the charging process. The multiple parasitic capacitors make the pixel electrode voltage being shared (partial pressure) due to the coupling effect (Crosstalk). The pixel electrode voltage is not enough and thus the display color appears anomalies. While the resolution is getting higher and higher, the coupling effect is more and more obvious.

### SUMMARY

The technical problem to be solved by the present application is to provide a pixel structure capable of improving the coupling effect. One of the objects of the present application is to provide a pixel structure and the pixel structure includes a pixel electrode; an active switch coupled to the pixel electrode; a common line, and a first storage capacitor formed between the pixel electrode and the common line; and a cross conductive line, and a second storage capacitor is formed between the pixel electrode and the cross conductive line.

In some embodiments, one end of the first storage capacitor is coupled to an active switch and another end of the first storage capacitor is coupled to the common line.

In some embodiments, one end of said first storage capacitor is coupled to an active switch and another end of the first storage capacitor is coupled to one of scan lines.

In some embodiments, the first storage capacitor and the second storage capacitor are formed by a first conductive layer, a second conductive layer and a third conductive layer; the first conductive layer is coupled with the active matrix; the second conductive layer is coupled with a first voltage line; the third conductive layer is coupled with a second voltage line; the first conductive layer, the second conductive layer and the third conductive layer are stacked with each other and arranged at interval; the first conductive layer, the second conductive layer and the third conductive layer are covered with each other in a vertical space.

In some embodiments, the first voltage line comprises a common line.

In some embodiments, the second voltage line and the common line are disposed within an overlapping coverage area of the first conductive layer.

In some embodiments, the first voltage line includes an upper scan line.

In some embodiments, at least one of the first conductive layer, the second conductive layer and the third conductive layer is made of transparent conductive material.

In some embodiments, the pixel electrode has at least two cruciform structures to form at least eight liquid crystal driving regions, and the cross conductive line comprises at least two cruciform structures, and covers on the pixel electrode relatively.

In some embodiments, the first conductive layer is arranged between the second conductive layer and the third conductive layer, the first storage capacitor is formed between the first conductive layer and the second conductive layer, and the second storage capacitor is formed between the first conductive layer and the third conductive layer.

In some embodiments, the second conductive layer is arranged between the first conductive layer and the third conductive layer, and the first storage capacitor is formed between the first conductive layer and the second conductive layers, and the third storage capacitor is formed between the second conductive layer and the third conductive layer.

In some embodiments, the material of the pixel electrode is made of transparent conductive material.

In some embodiments, the active switch is a thin film transistor, material of at least one the first conductive layer, the second conductive layer and the third conductive layer is identical to material of a first metal layer of the active switch.

In some embodiments, the active switch is a thin film transistor, material of at least one the first conductive layer, the second conductive layer and the third conductive layer is identical to material of a second metal layer of the active switch.

In some embodiments, the first conductive layer, the second conductive layer and the third conductive layer are made of conductive metal.

In some embodiments, the first conductive layer, the second conductive layer and the third conductive layer are arranged parallel to each other.

It is another object of the present application to provide a pixel structure. A pixel structure includes a pixel electrode; an active switch coupled to the pixel electrode; a common line, wherein a first storage capacitor is formed between the pixel electrode and the common line; and a cross conductive line, wherein a second storage capacitor is formed with the cross conductive line and the pixel electrodes; wherein the first storage capacitor and the second storage capacitor are formed by a first conductive layer, a second conductive layer and a third conductive layer, and the first conductive layer is coupled with drain of the active switch; the second conductive layer is coupled with the first voltage layer; the second conductive layer is coupled with the second voltage line; the third conductive layer is coupled with a second voltage line; the first conductive layer, the second conductive layer and the third conductive layer are stacked and arranged at intervals; the conductive layer, the second conductive layer and the third conductive layer are covered with each other in a vertical space; wherein the second voltage line and the common line are overlapped in an overlapping coverage area of the first conductive layer, wherein at least one of the first conductive layer, the second conductive layer and the third conductive layer is made of a transparent conductive material; wherein the pixel electrode has at least two cruciform structures to form at least eight liquid crystal driving regions; the cross conductive line has at least two cruciform structures and covers on the pixel electrode relatively.

A cross-shaped conductive line can be used to form at least two storage capacitors in the pixel structure while the pixel voltage of the pixel structure is maintained in order to reduce the influence of the parasitic capacitance so as to improve the influence of the coupling effect so that the display panel can be displayed normally.

### BRIEF DESCRIPTION OF THE DRAWINGS

In order to provide a clearer description of the embodiments of the present application, the accompanying drawings, which are intended to be used in the description of the embodiments, will be briefly described. It will be apparent that the following description is a part of the present application. In the ordinary skill of the present invention, other drawings may be obtained in accordance with these drawings without paying creative work. In the drawings:

FIG.1 is a schematic structural view of a pixel structure of the present application;

FIG.2 is a schematic structural view of a pixel structure of the present application;

FIG. 3 is a schematic structural view of a pixel structure of the present application;

FIG. 4 is a schematic structural view of a pixel structure of the present application;

FIG. 5 is a circuit diagram of a pixel structure of the present application;

FIG. 6 is a circuit diagram of a pixel structure of the present application;

FIG. 7 is a circuit diagram of a pixel structure of the present application;

FIG. 8 is a circuit diagram of a pixel structure of the present application;

FIG. 9 is a schematic structural view of a pixel structure of an embodiment of the present application;

FIG. 10 is a schematic structural view of a pixel structure of an embodiment of the present application;

FIG. 11 is a schematic structural view of a pixel structure of an embodiment of the present application;

FIG. 12 is a schematic structural view of a pixel structure of an embodiment of the present application;

FIG. 13 is a schematic representation of a pixel circuit structure of one embodiment of the present application;

FIG.14 is a schematic representation of a pixel circuit structure of one embodiment of the present application;

FIG. 15 is a schematic view of the mating of the first conductive layer, the second conductive layer and the third conductive layer of one embodiment of the present application;

FIG. 16 is a schematic view of the mating of the first conductive layer, the second conductive layer and the third conductive layer of one embodiment of the present application;

FIG. 17 is a schematic view of a pixel electrode and a cross conductive line of one embodiment of the present application.

### DETAILED DESCRIPTION OF PREFERRED EMBODIMENTS

The below in conjunction with the present invention in the accompanying drawings, technical solutions of embodiments of the present invention are clearly and completely described, obviously, the described embodiments are part of the embodiments of the present invention rather than all embodiments. Based on the embodiments of the present invention, all other embodiments of ordinary skill in the art without any creative effort shall fall within the scope of the present invention.

In the novel description of the practice, to be understood that the term “center”, “longitudinal”, “lateral”, “upper”, “lower”, “front”, “rear”, “left”, “orientation or positional relationship right”, “vertical”, “horizontal”, “top”, “bottom”, “inner”, “outer” and the like as indicated by the position or orientation based on the relationship shown in the drawings, for convenience of description only and to simplify the description of the present invention, not indicate or imply that the device or element referred to must have particular orientation, the orientation of a particular configuration and operation, cannot be construed as limiting the present disclosure. Further, the terms “first”, “second,” and the like for illustrative purposes only, and not intended to indicate or imply relative number of features of importance or implicitly specified as indicated. thus, there is defined “first,” “second,” and the like wherein can explicitly or implicitly include one or more of the feature in the present invention are novel description, unless otherwise specified, the meaning of “more” is two or more. In addition, the term “comprising” and any variations thereof are intended to cover non-exclusive inclusion.

In the description of the present application, it is to be understood that the terms “install”, “connect”, “connect” should be broadly understood, unless otherwise expressly defined and defined, for example, a fixed connection or a removable Connected, or integrally connected; can be a mechanical connection, it can be an electrical connection; can be directly connected, can also be indirectly connected through the intermediary, can be two components of the internal connectivity. In the description of the present invention, it is noted that, unless otherwise expressly specified or limited, the terms “mounted,” “connected to”, “connected” are to be broadly understood, for example, may be a fixed connection, may be a detachable connection, or integrally connected; may be a mechanical connector may be electrically connected; may be directly connected, can also be connected indirectly through intervening structures, it may be in communication the interior of the two elements. Those of ordinary skill in the art, to be understood that the specific meanings in the present invention by a specific situation.

The terminology used herein is for describing particular embodiments only and is not intended to limit embodiments to an exemplary embodiment. Unless the context clearly indicates otherwise, singular forms as used herein, “a”, “an” are intended to include the plural. It should also be understood that, as used herein the term “comprising” and/or “comprising,” provisions Chen Shu features, integers, steps, operations, elements, and/or components, but do not preclude the presence or addition of one or more other features, integers, steps, operations, elements, components, and/or combinations thereof.

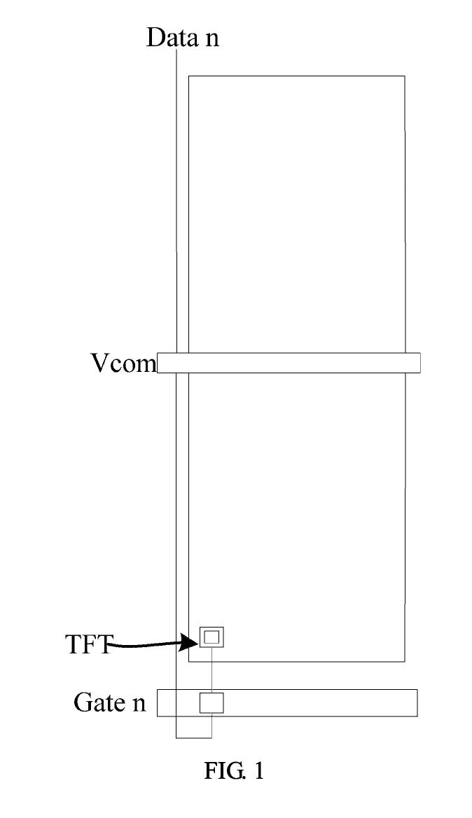

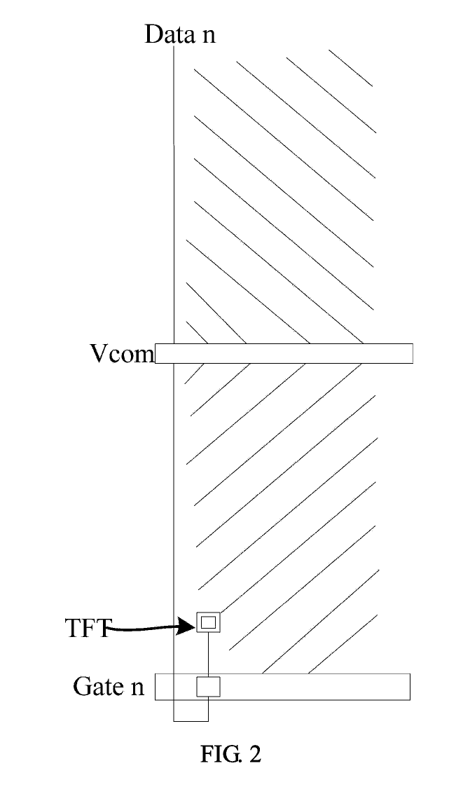

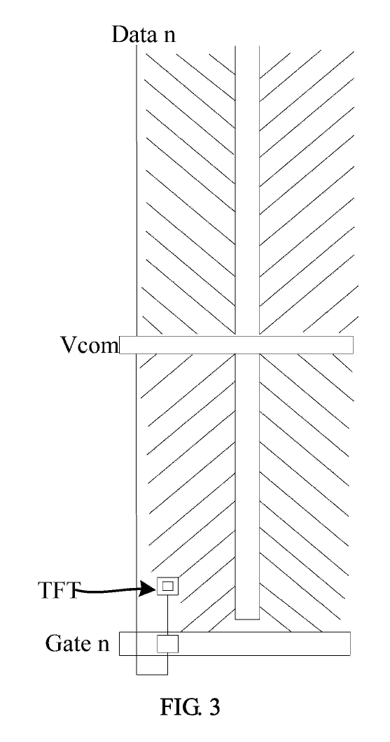

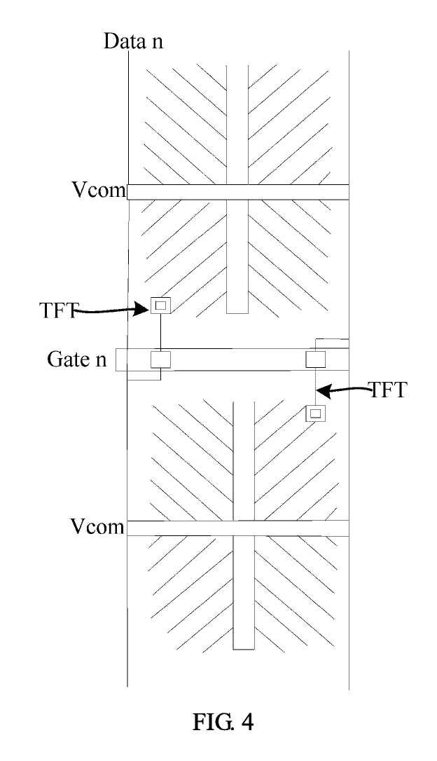

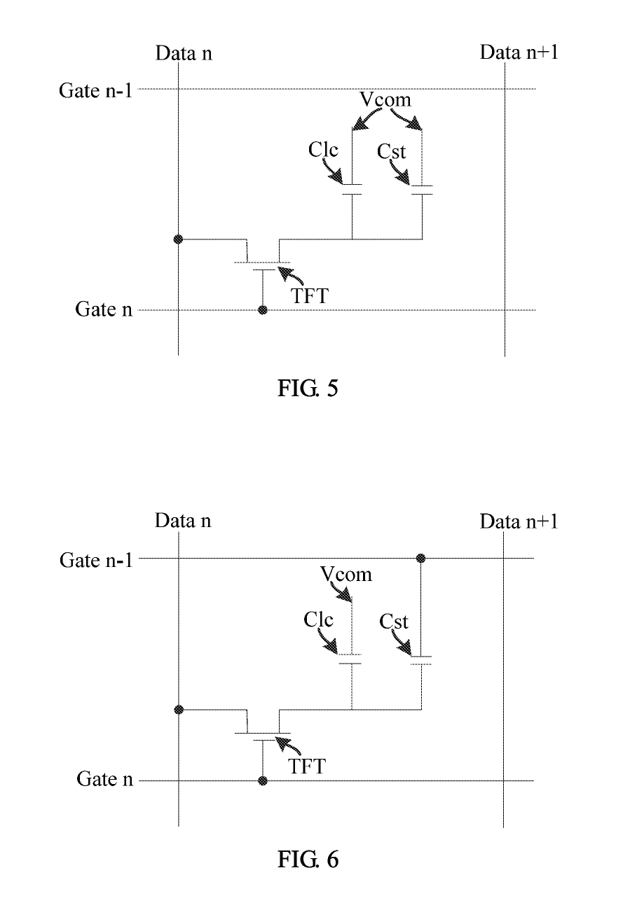

Since the charging time in the unit charging time is short, as shown in FIGS. 1 to 8, the pixel structure is coupled with the current data line Data n and the current scan line Gate n, specifically, in order to maintain the voltage Vpixel of the pixel structure. The line is coupled by an active switching (e.g., but not limited to thin film transistors), and the active switching TFTs are coupled with the pixel structures. The active switch TFT is turned on by the control line, and the current data line Data n is charged in the pixel structure. The current data line data n charges the liquid crystal capacitor Clc and the storage capacitor Cst during the charging of the pixel structure by voltage (Vdata). The pixel structure maintains the voltage (Vpixel) of the pixel structure by the storage capacitor Cst so that the display panel can display properly.

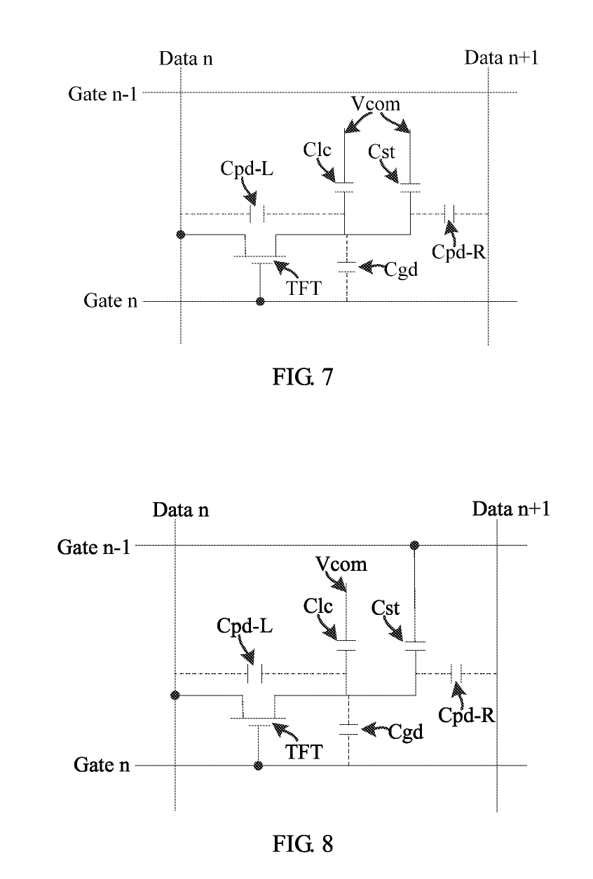

However, during the display panel display process, a different gray scale will be displayed. When the current data line Data n for the pixel structure of the charge voltage will continue to change, the the voltage of the pixel structure also changes. Due to the charged voltage of the current data line and multiple parasitic capacitances (Cpd-L, Cgd and Cpd-R) existing in the pixel structure, as shown in the dotted line part of FIGS. 7 and 8. The plurality of parasitic capacitance is between the dotted line part is a plurality of parasitic capacitances. The multiple parasitic capacitances (Cpd-L, Cgd And Cpd-R) will make the voltage of the pixel structure is divided be due to the coupling effect (Crosstalk). The voltage of the pixel structure is not enough and thus causes the display color anomalies.

In order to reduce the influence of multiple parasitic capacitances and improve coupling effect, the applicant further adopts the following two methods:

The first method is to set the data line away from the pixel structure, and thereby the parasitic capacitance is reduced. Then, the coupling effect becomes smaller, but the display panel of the plane space is increased. It is not easy for high resolution display panel.

The second method is to increase the storage capacitor Cst, and the storage capacitor is larger than the parasitic capacitance (Cpd-L, Cgd and Cpd-R). But it needs to increase the size of the conductive layer in the storage capacitor, and thus the pixel structure of the plane space is increased. With the resolution is getting higher and higher, the pixel electrode space is getting smaller and smaller. The storage capacitor will also become smaller, so the increment of the storage capacitor is not easy to use in high resolution display panels. Due to the restrictions of storage capacitor plane space size, so the coupling effect is improved by the increment of the storage capacitor and then reduced.

For this purpose, the applicant has designed another technical program to address the above technical issues, as follows:

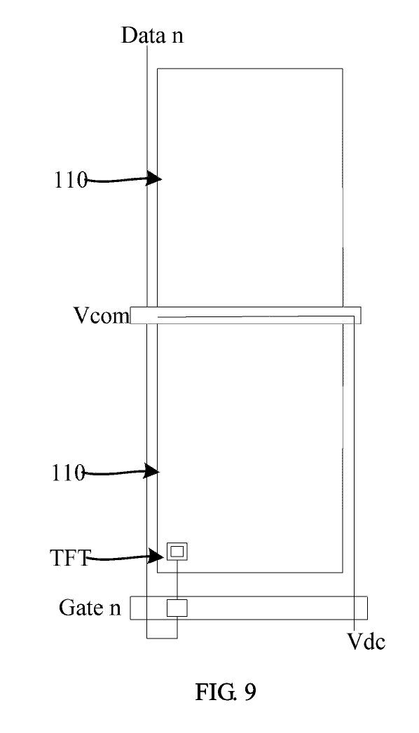

The present application will now be described in further detail with reference to FIGS. 9 to 16 and the preferred embodiments.

As shown in FIGS. 9 to 16, an embodiment of the present application discloses a pixel structure and a pixel circuit structure. The pixel structure and the pixel circuit structure of the present embodiment may be plural, and a plurality of pixel structures may be applied to different types of display device. The pixel structure of the present application is applied to the following display devices, for example, Twisted Nematic (TN) or Super Twisted Nematic (STN) type, In-Plane Switching (IPS), Vertical Alignment (VA), and High Vertical Alignment (HVA), and curved panels.

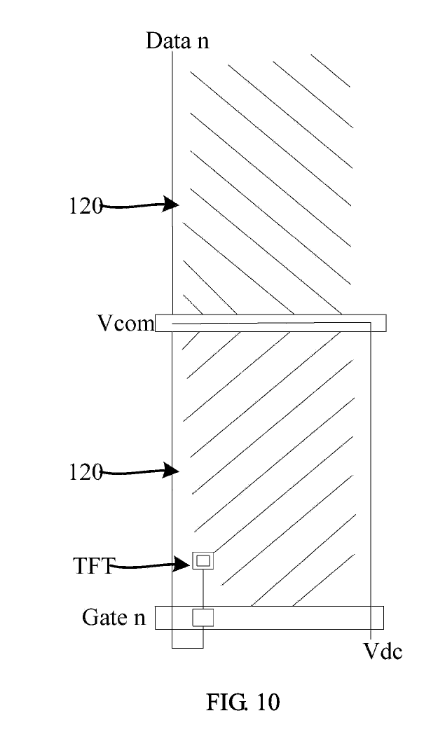

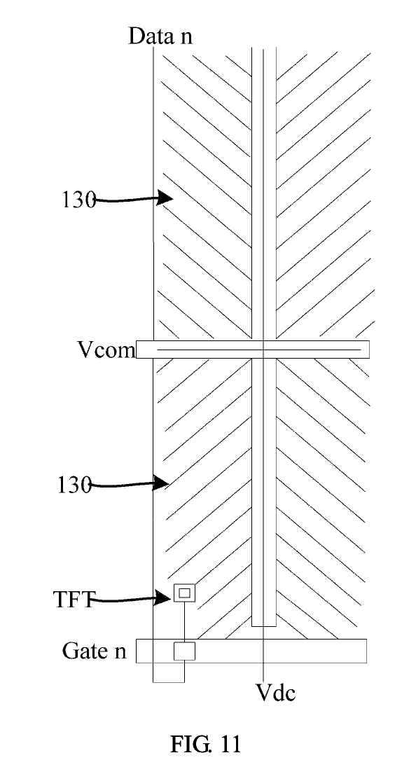

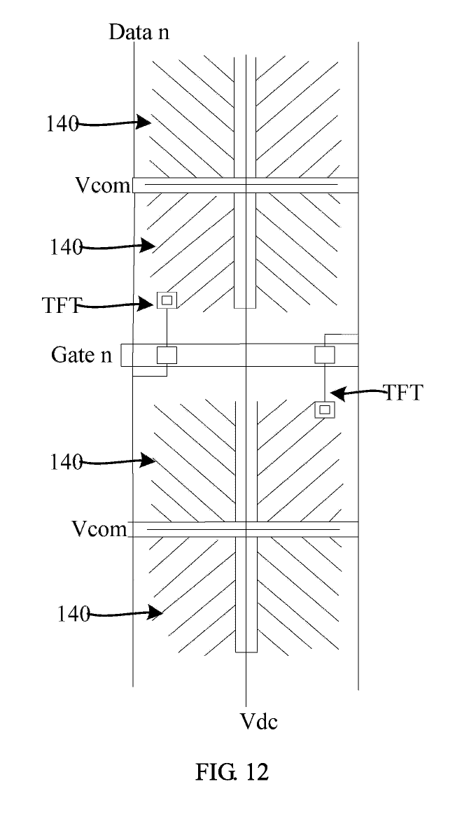

Specifically, the pixel structure of the embodiment of the present application may be four different pixel structures as shown in FIGS. 9 to 12, and it is to be noted that FIGS. 9 to 12 are merely examples of the pixel structure of the present embodiment. As a specific example, the pixel structure of the embodiment of the present application is not limited to these four structures. The pixel structure of the present application includes a pixel electrode, and FIG. 9 shows a pixel structure of the present application, which includes a first pixel electrode 110. FIG. 10 shows another pixel structure of the present application, and the pixel structure includes a second pixel electrode. FIG. 11 shows another pixel structure of the present application, and the pixel structure includes a third pixel electrode 130. FIG. 12 shows a further pixel structure of the present application, and the pixel structure includes a fourth pixel electrode 140.

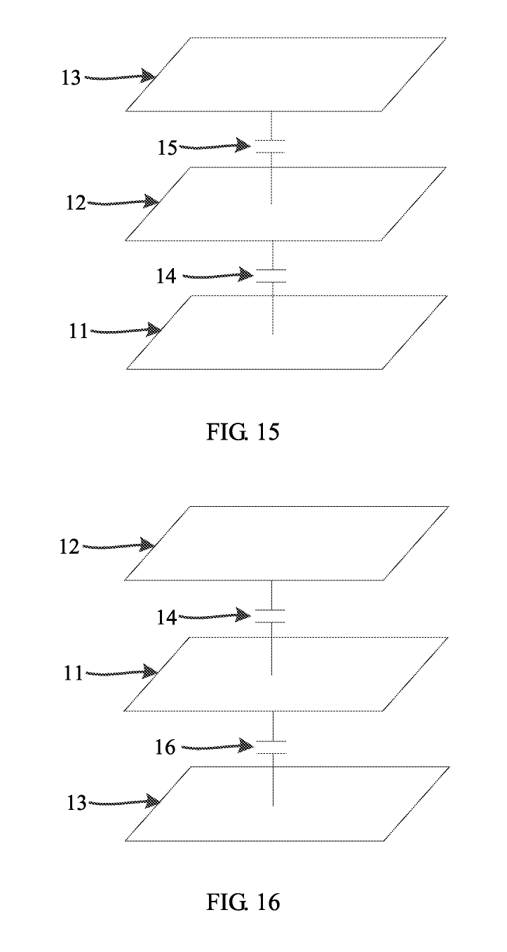

The pixel structure of the embodiment of the present application includes a first conductive layer 11, a second conductive layer 12, and a third conductive layer 13. As shown in FIGS. 15 and 16, the first conductive layer 11 is coupled with the drain of the active switch TFT (for example, but not limited to a thin film transistor). The second conductive layer 12 is coupled to a first voltage line. The third conductive layer 13 and the second voltage line are coupled. The first conductive layer 11, the second conductive layer 12, and the third conductive layer 13 are stacked and arranged at interval. The third conductive layer 11, the second conductive layer 12, and the third conductive layer 13 are covered with each other in a vertical space.

Compared with the prior art, the three conductive layers of the pixel structure of the embodiment of the present application can be energized, and the three conductive layers can form two storage capacitors, and the two storage capacitors simultaneously maintain the pixel voltage of the pixel structure to reduce the influence of plural parasitic capacitance. Thereby, the effect of the coupling effect is improved so that the display panel can be displayed properly.

In addition, the embodiment of the present application maintains the voltage of the pixel structure by two storage capacitors. the voltage size of the pixel structure is maintained by a storage capacitor as compared with the pixel structure in FIGS. 1 to 8, and the voltage of the pixel structure is maintained by the storage capacitor. The effect is better, and the voltage of the pixel structure is more stable. At the same time, the embodiment of the present application is provided by stacking the first conductive layer, the second conductive layer and the third conductive layer directly so as to avoid of increment of the plane size of the respective conductive layers. The present embodiment enhances the capacitor of the pixel structure without the condition of the number increment of the conductive layers. The voltage of the pixel structure of the capacitor greatly maintains the voltage of the pixel structure, so this disclosure is more suitable for high resolution display panel.

In some embodiments, more stacked conductive layers may also be formed in the pixel structure to form more storage capacitors (fourth storage capacitors, and fifth storage capacitors, etc.) in the pixel structure.

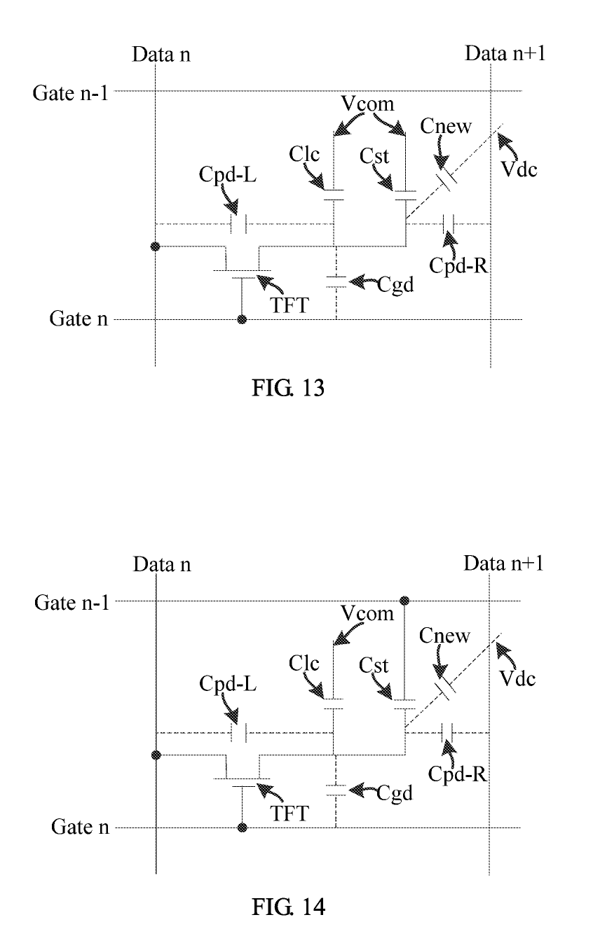

In the present embodiment of the present application, as shown in FIG. 16, FIG. 16 is a specific embodiment in which the first conductive, the second conductive layer and the third conductive layer are stacked. Specifically, the first conductive layer 11 is disposed between the second conductive layer 12 and the third conductive layer 13 so that a first storage capacitor 14 is formed between the first conductive layer 11 and the second conductive layer 12. As shown in FIGS. 13 and 14, the first storage capacitor 14 is the storage capacitor Cst. When the pixel structure adopts the structure in FIG. 16, the storage capacitor Cst is defined here as the first storage capacitor 14. A second storage capacitor 16 is formed between the first conductive layer and the third conductive layer 13, and the second storage capacitor 16 is a storage capacitor Cnew. The storage capacitor Cnew is defined as the second storage capacitor 16. The two storage capacitors (the first storage capacitor 11, the second storage capacitor 16) collectively maintain the potential of the pixel structure voltage without affecting the voltage of the pixel structure due to the voltage change the current data line during the charging process. And then the coupling effect will be improved.

However, it should be noted that FIG. 16 is a distribution of a specific conductive layer structure only for one embodiment of the present application. It may be distributed for other structures, for example, as shown in FIG. 15. FIG. 16 is an embodiment of the present invention. The first conductive layer, the second conductive layer, and the third conductive layer are stacked, and the second conductive layer 12 is provided between the first conductive layer 11 and the third conductive layer 13. The storage capacitor is formed between the first conductive layer 11 and the second conductive layer 12, as shown in FIG. 16. The storage capacitor is the first storage capacitor 14. As shown in FIG. 13 and FIG. 14, the first storage capacitor 14 is storage capacitance Cst. Here, the storage capacitor Cst is defined as the first storage capacitor 14. A third storage capacitor 15 is formed between the second conductive layer 12 and the third conductive layer 13. As shown in FIGS. 13 and 14, the third storage capacitor 15 is also shown as the storage capacitor Cnew (however, it is noted that a new storage capacitor, i.e., a second storage capacitor or a third storage capacitor, can be shown in FIGS. 13 and 14. And thus, Cnew in FIGS. 13 and 14 is only intended to illustrate Cnew as the second storage capacitor or the third storage capacitor. The second storage capacitor is defined to be different from the third storage capacitor 15. When FIG. 15 is used as the pixel structure, the third storage capacitor 15 is defined as the storage capacitance Cnew. Thus, the two storage capacitors (the first storage capacitor and the third storage capacitor) collectively maintain the potential of the pixel structure voltage without affecting the voltage of the pixel structure due to the charging voltage of the current data line during the charging process and thus the coupling effect is improved.

In the following description, the present embodiment replaces the second storage capacitor or the third storage capacitor with Cnew.

As shown in FIGS. 13 and 14, the first conductive layer 11 and the drain of the active switching TFT are coupled. The end of the capacitor Clc and the common line Vcom are coupled, and the capacitor Clc is coupled to the active switching TFT. The thin film transistor is coupled to the current data line Data n, and the current scan line Gate n. When the current scan line controls film transistor being turned on, the current data line is charged by the thin film transistor for the pixel structure. Specifically, the liquid crystal capacitor Clc, and two memory capacitors (Cst and Cnew, specifically in FIG. 16, i.e., the first storage capacitor and the second storage capacitor; or specifically in FIG. 15, i.e., the first storage capacitor and the third storage capacitor).

Further, the first voltage line includes the previous scan line Gate n-1, as shown in FIG. 14. The second conductive layer 12 is coupled to the previous scan line. During the charging process of the pixel structure, by the current scan line Gate n, the active switching TFT is controlled to be turned on, so that the current data line Data n is charged for the pixel structure. The previous scan line is on the previous line of the current scan line and the second conductive layer 12 is pre-charged by the previous scan line. The second conductive layer 12 has a voltage and reduces the charging time when the current data line is charged. The second conductive layer 12 reaches quickly to a predetermined potential. This is a specific way of coupling the second conductive layer to the first voltage line. It should be noted that the second conductive layer may also be coupled to other first voltage lines, such as shown in FIG. 13. The first voltage line includes a common line Vcom. A second conductive layer 12 is coupled to a common line Vcom. The common line Vcom is the second conductive layer, which is simple in construction.

In the embodiment of the present application, the third conductive layer 13 and the second voltage line are coupled, as shown in FIGS. 9 to 14. The second voltage line Vdc of the embodiment of the present application is coupled to a DC voltage. The voltage range of the common line connecting with the second conductive layer is 7.5V or 0V. The voltage of the data lines is −5 to 15 V. The voltage of the scan lines is −6 to 35 V. Since the voltage of the third conductive layer connecting with the second layer and the voltage of the third conductive layer connecting with the first conductive layer are not the same, so storage capacitors can be formed between the third conductive layer and the first conductive layer or the second conductive layer.

In the embodiment of the present application, as shown in FIGS. 9 to 12, the manufacturing method of the pixel structure of the present application may include:

Forming a first conductive layer 11 on a substrate (not shown, for example, a transparent substrate of an active switch array substrate)

Forming a second conductive layer 12 on the substrate;

A third conductive layer 13 is formed on the substrate. The first conductive layer 11, the second conductive layer 12, and the third conductive layer 13 are stacked and arranged at intervals. The first conductive layer 11, the second conductive layer 12 and the third conductive layer 13 are covered with each other in a vertical space;

Forming an active switching TFT in the pixel region after forming the first conductive layer 11. The drain of the first conductive layer 11 and the active switching TFT are coupled; and the second conductive layer 12 is coupled with the first voltage line. The third conductive layer 13 is coupled to the second voltage line.

In some embodiments, when the first conductive layer 11 is formed, a scan line Gate is formed on the substrate at the same time. For example, as shown in FIG. 9 to FIG. 12, in the same mask process, the scan lines Gate and the common lines Vcom may be formed at the same time. At least, a portion of the common line Vcom may be used as the first conductive layer 11.

In some embodiments, when the second conductive layer 12 is formed, the pixel electrodes 110, 120, 130, 140 are simultaneously formed on the substrate. For example, as shown in FIGS. 9 to 12, may utilize at least a portion of the pixel electrode 110, 120, 130, 140 as the second conductive layer 12. The materials of the pixel electrodes 110, 120, 130, 140 may be, for example, ITO, IZO, AZO, ATO, GZO, TCO, ZnO or polyethylenedioxythiophene (PEDOT).

In some embodiments, when the third conductive layer 13 is formed, the material of the third conductive layer 13 is same as the first metal layer or the second metal layer of the active switch TFT. For example, as shown in FIGS. 9 to 12, the material of the third conductive layer 13 may be identical to the material of the second switching TFT active metal layer (source and drain) 12.

In some embodiments, at least one of the first conductive layer 11, the second conductive layer 12, and the third conductive layer 13 is a material that is the same as the first metal layer of the active switching TFT, for example, Al, Ag, Cu, Mo, Cr, W, Ta, Ti, nitrided metal or any combination of the above-mentioned alloys. The multi-layer structure has a heat-resistant metal film and a low resistivity film, such as a molybdenum nitride film and an aluminum film Layer structure.

In some embodiments, at least one of the first conductive layer 11, the second conductive layer 12, and the third conductive layer 13 is the second metal layer of the material that is the same as the second metal layer of the active switch. For example, Mo, Cr, Ta, Ti or an alloy thereof.

In some embodiments, at least one of the first conductive layer 11, the second conductive layer 12, and the third conductive layer 13 are made of a transparent conductive material, for example, ITO, IZO, AZO, ATO, GZO, TCO, ZnO or polyethylenedioxythiophene (PEDOT).

In the embodiment of the present application, as shown in FIGS. 13 and 14, the pixel circuit structure of the present application includes

data line; a scan line Gate defines a pixel area with the data line Data; an active switching TFT is coupled to the data line Data and the scan line Gate; a liquid crystal capacitor Clc is coupled to the active switching TFT; a first storage capacitor Cst is coupled to the active switching TFT; a second storage capacitor Cnew is coupled to the first storage capacitor Cst and coupled to a DC voltage Vdc.

In some embodiments, one end of the first storage capacitor Cst is coupled to the active switching TFT, and the other end of the first storage capacitor Cst is coupled to a common line Vcom, as shown in FIG.13.

In some embodiments, one end of the first storage capacitor Cst is coupled to the active switching TFT and the other end of the first storage capacitor Cst is coupled to one of the scan line Gate (the previous scan line Gate n-1), as shown in FIG. 14.

In some embodiments, the first storage capacitor Cst and the second storage capacitor Cnew are formed by a first conductive layer, a second conductive layer, and a third conductive layer. The first conductive layer and the drain of the active switch are coupled. The second conductive layer and the first voltage line are coupled. The third conductive layer and the second voltage line are coupled. The first conductive layer, the second conductive layer and the third conductive layer are stacked and arranged at intervals. The first conductive layer, the second conductive layer, and the third conductive layer are covered with each other in a vertical space.

In some embodiments, the first voltage line includes a common line Vcom.

In some embodiments, the second voltage line and the common line Vcom are disposed in a first conductive layer coverage area.

In some embodiments, the first voltage line includes an upper scan line Gate n-1.

In the embodiment of the present disclosure, the first conductive layer 11, the second conductive layer 12, and the third conductive layer 13 are respectively made of a conductive metal. This is a specific structure which the present disclosure disposes a first conductive layer, a second conductive layer and the third conductive layer. The three conductive layers (the first conductive layer 11, the second conductive layer 12, and the third conductive layer 13) are made of a conductive metal, and the conductive metal has a good conductive effect. The conductive metal of an embodiment of the present application may be Al, Mo, Cu, Ti, Ag or an alloy thereof.

It is to be noted that the three conductive layers (the first conductive layer 11, the second conductive layer 12 and the third conductive layer 13) are made of a conductive metal or other conductive material in a specific manner of the present application. The application embodiments may also be used in other ways:

For the first example, the first conductive layer 11 and the second conductive layer 12 are made of a conductive metal, and the third conductive layer 13 is made of a transparent conductive material. This is another specific structure of the first conductive layer 11, the second conductive layer 12, and the third conductive layer 13 in the present embodiment. Both the first conductive layer 11 and the second conductive layer 12 are made of a conductive metal. The metal conductive effect is good. The third conductive layer 13 is made of a transparent conductive material, for example, ITO, IZO, AZO, ATO, GZO, TCO, ZnO or polyethylenedioxythiophene (PEDOT).

For the second example, the first conductive layer 11 is made of a conductive metal, and the second conductive layer 12 and the third conductive layer 13 are made of a transparent conductive material, respectively. This is a further specific structure of the first conductive layer 11, the second conductive layer 12 and the third conductive layer 13 in the present embodiment. the first conductive layer 11 is made of a conductive metal, and the conductive metal has a good conductive effect; The conductive layer 12 and the third conductive layer 13 are made of a transparent conductive material, and the conductive effect can be achieved.

In the embodiment of the present application, as shown in FIGS. 9 to 12, the second voltage line Vdc and the common line Vcom are partially overlapped in space specifically. The second voltage line and the common line are covered in the first conductive layer and they are overlapped in the area. If the two or more lines are arranged side by side, the parasitic capacitance are generated from each other, and interference is generated from each other. In this embodiment, the common line Vcom and the second voltage line Vdc are partially overlapped in space to prevent generation of parasitic capacitance, and to improve anti-interference ability.

Further, the three conductive layers (the first conductive layer 11, the second conductive layer 12, and the third conductive layer 13) of the present embodiment are parallel to each other, so that the space occupied by the three in the plane space is made more So that the effect of applying the pixel structure of the embodiment of the present application to the display panel is better.

As shown in FIGS. 11, 12 and 17, a pixel structure of the present disclosure includes: a pixel electrode 150; an active switch is coupled to the pixel electrode 150; a common line, and a first storage capacitor is formed between the pixel electrode and the common line; a cross conductive line, a second storage capacitor is formed between the pixel electrode 150 and the cross conductive line.

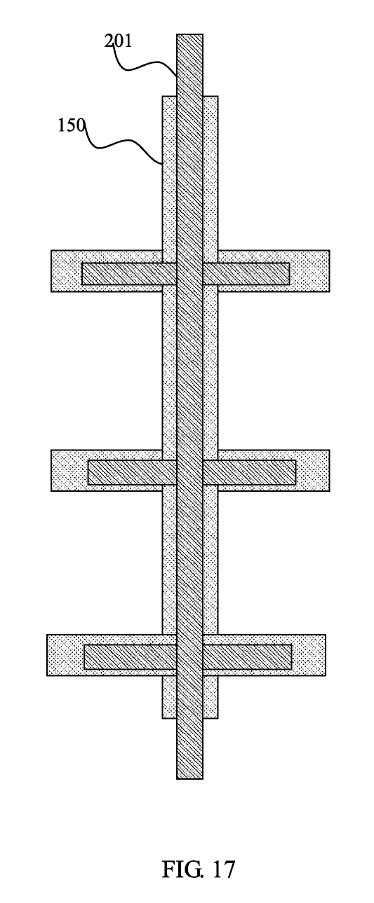

In an embodiment, as shown in FIG. 17, the pixel electrode 150 may have three cross-shaped structures, and twelve liquid crystal driving regions may be formed. Corresponding to the pixel electrode 150, the third conductive layer 201 may also have three cross-shaped structures (cross-shaped conductive wires) to correspond to the pixel electrode 150 in correspondence.

In another embodiment of the present application, the present application embodiment also discloses an array substrate. A common line, a data line and a scan line are provided on the array substrate. The array substrate further includes a pixel structure. The pixel structures are respectively coupled to the data lines and the scan lines. The common lines, data lines, scan lines, and pixel structures on the array substrate of the present embodiment can be found in the common lines, data lines, scan lines, pixel structures, or common lines on the array substrate of the above-mentioned embodiment. Or common lines, data line, scan lines, and pixel structures can be seen in the common lines, data lines, scan lines, pixel structures, and mutual cooperation and connection relationships in FIGS. 9 to 17. The array substrate of the present embodiment has a plurality of pixel structures, and each pixel structure can be seen in FIGS. 9 to 17. The pixel structure, the common line, the data line, the scan line, and the like are no longer described in detail.

In still another embodiment of the present application, the present embodiment also discloses a display panel and a color film substrate. The array substrate is provided with common lines, data lines and scan lines. The array substrate also includes pixel structures, the pixel structures being coupled to the data lines and the scan lines, respectively. The common line, the data line, the scan line, the pixel structure, or the common line in the display panel can be seen in the above-mentioned embodiment. The common line, the data lines, the scan lines, and the pixel structures can be seen in the common lines, the data lines, the scan lines, the pixel structures, and mutual cooperation and connection relationships in FIGS. 9 to 17. The array substrate of the present embodiment has a plurality of pixel structures, and each pixel structure can be seen in FIGS. 9 to 17, where the pixel structure, the common line, the data line, the scan line, and the like are no longer described in detail.

In still another embodiment of the present application, the present embodiment also discloses a display device. It includes a display panel and the display panel includes a color film substrate and an array substrate. Common lines, data lines and scan lines are arranged on the array display. The array substrate further includes the pixel structure. The pixel structure is respectively coupled with the data line and scan line. The common line, the data line, the scan line, the pixel structure in the display panel of the present embodiment can be seen in the common line, the data line, the scan line, the pixel structure of the above-mentioned embodiments. Or the common lines, the data lines, the scan lines, and the pixel structures of the present embodiment can be seen in the common lines, data lines, scan lines, pixel structures, mutual cooperation and connection relationships in FIGS. 9 to 16. The array substrate of the present embodiment has a plurality of pixel structures, and each pixel structure can be seen in FIGS. 9 to 16, where the pixel structure, the common line, the data line, the scan line, and the like are no longer described in detail. The display device of the present embodiment may be a liquid crystal display or other display device. When the display device is a liquid crystal display, the backlight module may be used as a light source for supplying a sufficient light source with uniform brightness and uniform distribution. The backlight module of the present embodiment adopts a front light type or a backlight type. It should be noted that the backlight module of the present embodiment is not limited thereto.

The foregoing is intended only as a specific embodiment of the present application, but the scope of protection of the present application is not limited thereto. It will be readily apparent to those skilled in the art that various equivalents may be readily apparent to those skilled in the art Modified or replaced, and such modifications or substitutions are intended to be included within the scope of the present application. Accordingly, the scope of protection of the present application is subject to the scope of protection of the claims.

What is claimed is:

1. A pixel structure comprising:
a pixel electrode;
an active switch coupled to the pixel electrode;
a common line, and a first storage capacitor formed between the pixel electrode and the common line; and
a cross conductive line, and a second storage capacitor formed between the cross conductive line and the pixel electrode.

2. The pixel structure of claim 1, wherein one end of the first storage capacitor is coupled to an active switch and another end of the first storage capacitor is coupled to the common line.

3. The pixel structure of claim 1, wherein one end of said first storage capacitor is coupled to an active switch and another end of the first storage capacitor is coupled to one of scan lines.

4. The pixel structure of claim 1, wherein the first storage capacitor and the second storage capacitor are formed by a first conductive layer, a second conductive layer and a third conductive layer, and the first conductive layer is coupled with the active matrix; the second conductive layer is coupled with a first voltage line; the third conductive layer is coupled with a second voltage line; the first conductive layer, the second conductive layer and the third conductive layer are stacked with each other and arranged at interval; the first conductive layer, the second conductive layer and the third conductive layer are covered with each other in a vertical space.

5. The pixel structure of claim 4, wherein the first voltage line comprises a common line.

6. The pixel structure of claim 4, wherein the second voltage line and the common line are disposed within an overlapping coverage area of the first conductive layer.

7. The pixel structure of claim 4, wherein the first voltage line comprises a scan line.

8. The pixel structure of claim 4, wherein at least one of the first conductive layer, the second conductive layer and the third conductive layer is made of a transparent conductive material.

9. The pixel structure of claim 1, wherein the pixel electrode has at least two cruciform structures to form at least eight liquid crystal driving regions, and the cross conductive line comprises at least two cruciform structures, and covers on the pixel electrode relatively.

10. The pixel structure of claim 4, wherein the first conductive layer is arranged between the second conductive layer and the third conductive layer, the first storage capacitor is formed between the first conductive layer and the second conductive layer, and the second storage capacitor is formed between the first conductive layer and the third conductive layer.

11. The pixel structure of claim 4, wherein the second conductive layer is arranged between the first conductive layer and the third conductive layer, and the first storage capacitor is formed between the first conductive layer and the second conductive layers, and the third storage capacitor is formed between the second conductive layer and the third conductive layer.

12. The pixel structure of claim 1, wherein material of the pixel electrode is made of a transparent conductive material.

13. The pixel structure of claim 4, wherein the active switch is a thin film transistor, material of at least one the first conductive layer, the second conductive layer and the third conductive layer is identical to material of a first metal layer of the active switch.

14. The pixel structure as claimed in claim 4, wherein the active switch is a thin film transistor, material of at least one the first conductive layer, the second conductive layer and the third conductive layer is identical to material of a second metal layer of the active switch.

15. The pixel structure of claim 4 wherein the first conductive layer, the second conductive layer and the third conductive layer are made of conductive metal.

16. The pixel structure of claim 4 wherein the first conductive layer, the second conductive layer and the third conductive layer are arranged parallel to each other.

17. A pixel structure comprising:
a pixel electrode;
an active switch coupled to the pixel electrode;
a common line, wherein a first storage capacitor is formed between the pixel electrode and the common line; and
a cross conductive line, wherein a second storage capacitor is formed with the cross conductive line and the pixel electrodes;
wherein the first storage capacitor and the second storage capacitor are formed by a first conductive layer, a second conductive layer and a third conductive layer, and the first conductive layer is coupled with drain of the active switch; the second conductive layer is coupled with the first voltage layer; the second conductive layer is coupled with the second voltage line; the third conductive layer is coupled with a second voltage line; the first conductive layer, the second conductive layer and the third conductive layer are stacked and arranged at intervals; the conductive layer, the second conductive layer and the third conductive layer are covered with each other in a vertical space;
wherein the second voltage line and the common line are overlapped in an overlapping coverage area of the first conductive layer, wherein at least one of the first conductive layer, the second conductive layer and the third conductive layer is made of a transparent conductive material;
wherein the pixel electrode has at least two cruciform structures to form at least eight liquid crystal driving regions; the cross conductive line has at least two cruciform structures and covers on the pixel electrode relatively.
